(19) United States
(12) Patent Application Publication
(10) Pub. No.: US 2011/0201747 A1
(43) Pub. Date: Aug. 18, 2011

(54) BRANCHED POLYARYLENE ETHERS AND THERMOPLASTIC MOLDING COMPOUNDS CONTAINING SAID ETHERS

(75) Inventors: Martin Weber, Maikammer (DE); Alexander Khvorost, Laudenbach (DE); Bernd Bruchmann, Freinsheim (DE)

(73) Assignee: BASF SE, Ludwigshafen (DE)

(21) Appl. No.: 13/125,898

(22) PCT Filed: Oct. 19, 2009
(86) PCT No.: PCT/EP2009/063635

§ 371 Date: Apr. 25, 2011

(30) Foreign Application Priority Data
Oct. 23, 2008 (EP) 08167413.7

(51) Int. Cl. C08L 61/16; C08G 14/00

(52) U.S. Cl. 524/540; 528/125

(57) ABSTRACT

The present invention relates to branched polyarylene ethers (A) comprising branching sites of the formula (I):

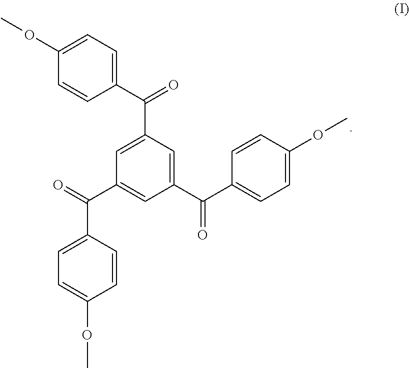

The present invention further relates to a process for preparing the branched polyarylene ethers (A) and to thermoplastic molding materials comprising the branched polyarylene ethers (A) and further thermoplastic polymers (B). The present invention finally relates to the use of the thermoplastic molding materials for producing moldings, and to moldings obtainable from the aforementioned thermoplastic molding materials.

The present invention relates to branched polyarylene ethers (A) comprising branching sites of the formula (I):

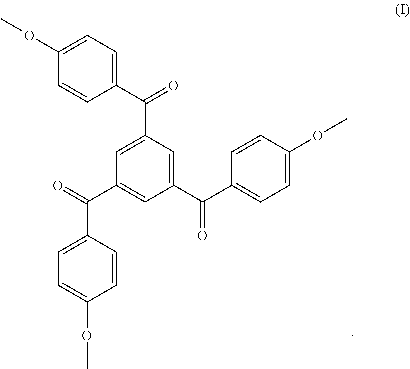

The present invention further relates to a process for preparing the branched polyarylene ethers (A) and to thermoplastic molding materials comprising the branched polyarylene ethers (A) and further thermoplastic polymers (B). The present invention finally relates to the use of the thermoplastic molding materials for producing moldings, and to moldings obtainable from the aforementioned thermoplastic molding materials.

Polyarylene ethers form part of the group of the high-performance thermoplastics and, owing to their high heat distortion resistance and chemical stability, find use in high-stress applications; see G. Blinne, M. Knoll, D. Müller, K. Schlichting, Kunststoffe 75, 219 (1985), E. M. Koch, H.-M. Walter, Kunststoffe 80, 1146 (1990) and D. Döring, Kunststoffe 80, 1149 (1990).

Owing to the high glass transition temperature, the polyarylene ethers have comparatively high melt viscosity, and so very high processing temperatures are needed for thermoplastic processing of this substance class (for example by injection molding, extrusion). To fill complicated molds, it is necessary in many cases to select temperatures at which side reactions such as those which increase molecular weight, or crosslinking, gain significance.

To increase the flowability, lubricants, for example stearates or oligomeric fatty acid esters, are typically used (R. Gächter, H. Müller, Kunststoff-Additive [Plastics Additives], p. 443 ff, 3rd edition, Hanser Verlag Munich 1989). Owing to the high thermal stress, such additives, however, lead to discoloration of the finished products.

In order to extend the available spectrum of properties of the polyarylene ethers, branched polyarylene ethers have been developed. For instance, German published specification DE-A 2305413 discloses branched polyarylene ether sulfones which, compared to the linear polyarylene ether sulfones, are less prone to stress cracking corrosion, and have improved stability compared to unsaturated polyester resins and reduced combustibility. The stress cracking resistance of mixtures of thermoplastic polymers, especially of linear polyarylene ether sulfones with the branched polyarylene ether sulfones mentioned, is, however, insufficient for many applications.

An essay which appeared in Macromolecular Symposia 2003, 199, 243-252 about the synthesis and characterization of branched polyarylene ethers discloses that the use of branched polyether sulfones generally improves the flowabilities of the polyarylene ether sulfones, but worsens mechanical properties, for example toughness.

EP-A 1 436 344 discloses that the addition of branched polyarylene ether sulfones with 1,1,1-tris(4-hydroxyphenyl)ethane units as branching sites improves the flowability and melt stability of known linear polyether sulfones. However, the products thus obtained are still inadequate with regard to flowability.

A further approach to improving the flowability of polyarylene ethers is the addition of LC polymers (G. Kiss, Polym. Eng. & Sci., 27, 410 (1987), K. Engberg, O. Strömberg, J. Martinsson, U. W. Gedde, Polym. Eng. & Sci., 34, 1336 (1994)). However, the increase in flowability is accompanied by a massive deterioration in the toughness of corresponding products.

It was an object of the present invention to provide branched polyarylene ethers which are improved over the prior art and which, in a blend with thermoplastic molding materials, lead to an improvement in the flowability. It was an additional object of the present invention to provide polyarylene ether sulfones with improved flowability, which simultaneously have a high chemical stability. In particular, the polyarylene ether sulfones of the present invention should have a high stress cracking resistance. The mechanical properties should not be adversely affected compared to the use of known branched polyarylene ether sulfones. In particular, the polyarylene ether sulfones should have a high toughness.

The aforementioned objects are achieved by the inventive branched polyarylene ethers and mixtures thereof with further thermoplastic polymers, especially polyarylene ether sulfones. Preferred embodiments can be taken from the claims and the description which follows. Combinations of preferred embodiments do not leave the scope of the present invention.

The inventive polyarylene ethers (A) comprise branching sites of the formula (I):

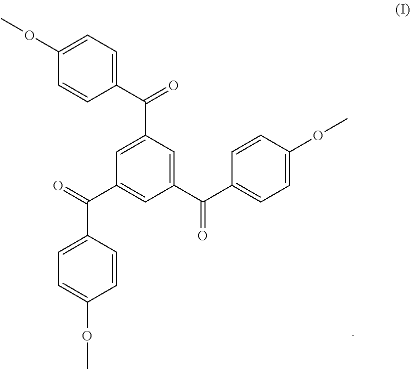

In the context of the present invention, a branching site is understood to mean a chain unit which is bonded to further units of the polymer via at least three oxygen atoms. Accordingly, the branching site of the formula (I) joins three chain sections of the polyarylene ether (A), the branching site being joined to the chain sections of the polyarylene ether (A) via an oxygen atom. According to the proportion of the inventive branching sites, the average result is portions of singularly or multiply branched polyarylene ethers (A).

The substance class of the polyarylene ethers is known per se to those skilled in the art. In the context of the present invention, “polyarylene ethers” are understood to mean polymers which have at least one chain unit with at least one arylene unit incorporated into the polymer chain via an oxygen atom.

The polyarylene ethers (A) of the present invention are preferably polyarylene ether sulfones.

The substance class of the polyarylene ether sulfones is likewise known per se to those skilled in the art. In the context of the present invention, “polyarylene ether sulfones” are understood to mean polymers which comprise at least one chain unit which has at least one arylene unit incorporated into the polymer chain via an oxygen atom and at least one arylene unit incorporated into the polymer chain via an —SO₂— group.

Polyarylene ethers (A) preferred in the context of the present invention are polyarylene ether sulfones comprising

(A1) from 1 to 99.9% by weight of at least one unit of the general formula (II)

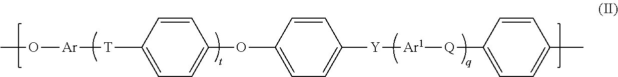

where
t, q: each independently 0, 1, 2 or 3,
Q, T, Y: each independently a chemical bond or a group selected from —O—, —S—, —SO₂—, S═O, C═O, —N═N—, —CR^{a}R^{b}—, where R^{a} and R^{b} are each independently a hydrogen atom or a C₁-C₁₂-alkyl, C₁-C₁₂-alkoxy or C₆-C₁₈-aryl group, where at least one of Q, T and Y is different than —O—, and at least one of Q, T and Y is —SO₂—, and
Ar, Ar¹: each independently a C₆-C₁₈-arylene group,
   and

(A2) from 0.1 to 99% by weight of branching sites of the formula (I) as defined above, where the sum of the percentages by weight of (A1) and (A2) adds up to 100% by weight.

If Q, T or Y, under the abovementioned prerequisites, is a chemical bond, this is understood to mean that the group adjacent to the left and the group adjacent to the right are bonded directly to one another via a chemical bond.

Preferably, Q, T and Y in formula (II), however, are independently selected from —O— and —SO₂—, with the proviso that at least one of the group consisting of Q, T and Y is —SO₂—.

When Q, T or Y are —CR^{a}R^{b}—, R^{a} and R^{b} are each independently a hydrogen atom or a C₁-C₁₂-alkyl, C₁-C₁₂-alkoxy or C₆-C₁₈-aryl group.

Preferred C₁-C₁₂-alkyl groups comprise linear and branched, saturated alkyl groups having from 1 to 12 carbon atoms. Particular mention should be made of the following radicals: C₁-C₆-alkyl radicals such as methyl, ethyl, n-propyl, isopropyl, n-butyl, sec-butyl, 2- or 3-methylpentyl and longer-chain radicals such as unbranched heptyl, octyl, nonyl, decyl, undecyl, lauryl, and the singularly or multiply branched analogs thereof.

Useful alkyl radicals in the aforementioned usable C₁-C₁₂-alkoxy groups include the alkyl groups having from 1 to 12 carbon atoms defined above. Cycloalkyl radicals usable with preference comprise especially C₃-C₁₂-cycloalkyl radicals, for example cyclopropyl, cyclobutyl, cyclopentyl, cyclohexyl, cycloheptyl, cyclooctyl, cyclopropylmethyl, cyclopropylethyl, cyclopropylpropyl, cyclobutylmethyl, cyclobutylethyl, cyclpentylethyl, -propyl, -butyl, -pentyl, -hexyl, cyclohexylmethyl, -dimethyl, -trimethyl.

Ar and Ar¹ are each independently a C₆-C₁₈-arylene group. Proceeding from the starting materials described below, Ar is preferably derived from an electron-rich, readily electrophilically attackable aromatic substance which is preferably selected from the group consisting of hydroquinone, resorcinol, dihydroxynaphthalene, especially 2,7-dihydroxynaphthalene, and 4,4′-bisphenol. Ar¹ is preferably an unsubstituted C₆- or C₁₂-arylene group.

Useful C₆-C₁₈-arylene groups Ar and Ar¹ are especially phenylene groups, such as 1,2-, 1,3- and 1,4-phenylene, naphthylene groups, for example 1,6-, 1,7-, 2,6- and 2,7-naphthylene, and the arylene groups derived from anthracene, phenanthrene and naphthacene.

Preferably, Ar and Ar¹ in the preferred embodiments of the formula (II) are each independently selected from the group consisting of 1,4-phenylene, 1,3-phenylene, naphthylene, especially 2,7-dihydroxynaphthalene, and 4,4′-bisphenylene.

Units (A1) present with preference in the inventive polyarylene ethers (A) are those which comprise at least one of the following repeat structural units IIa to IIo:

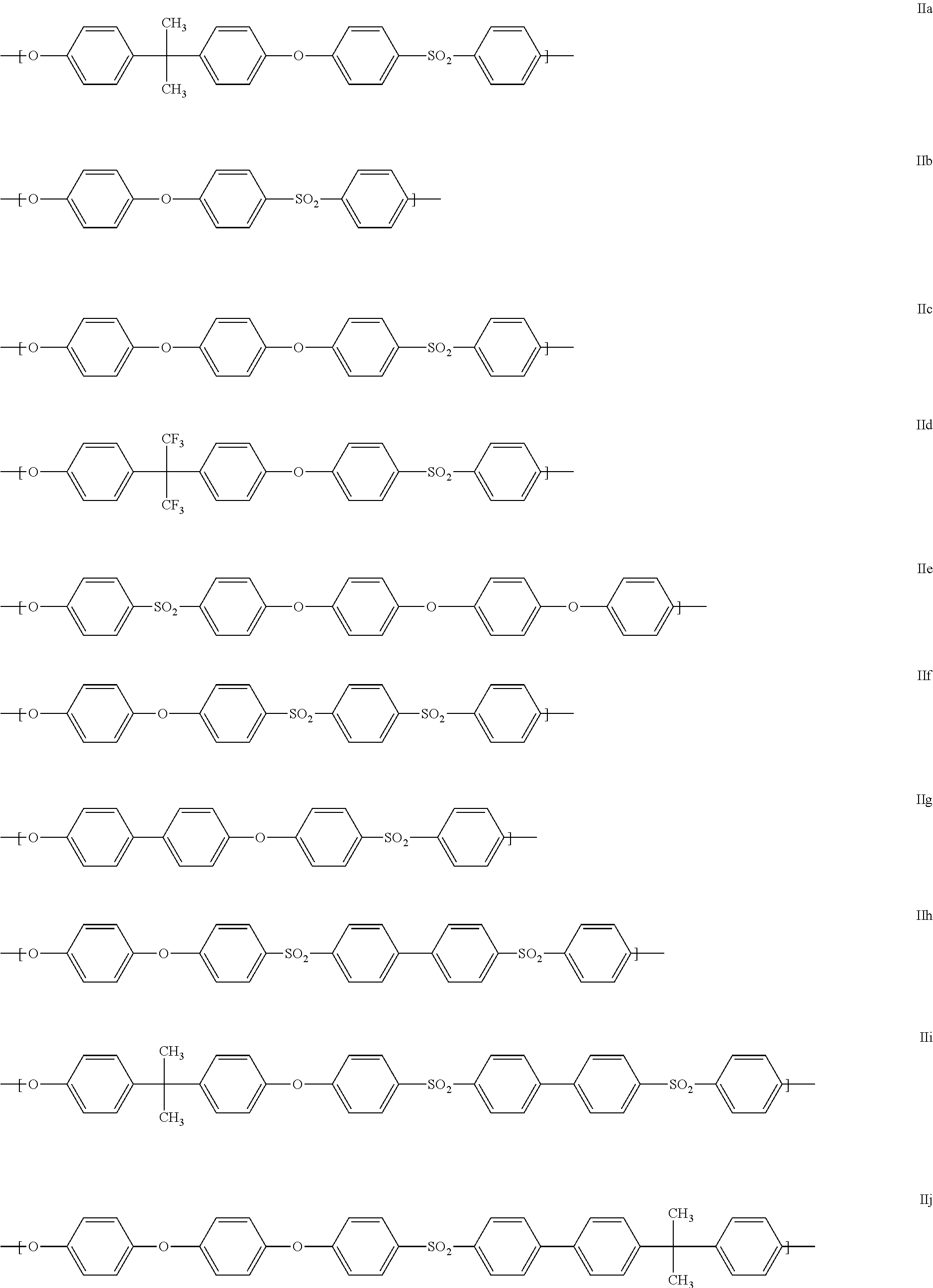

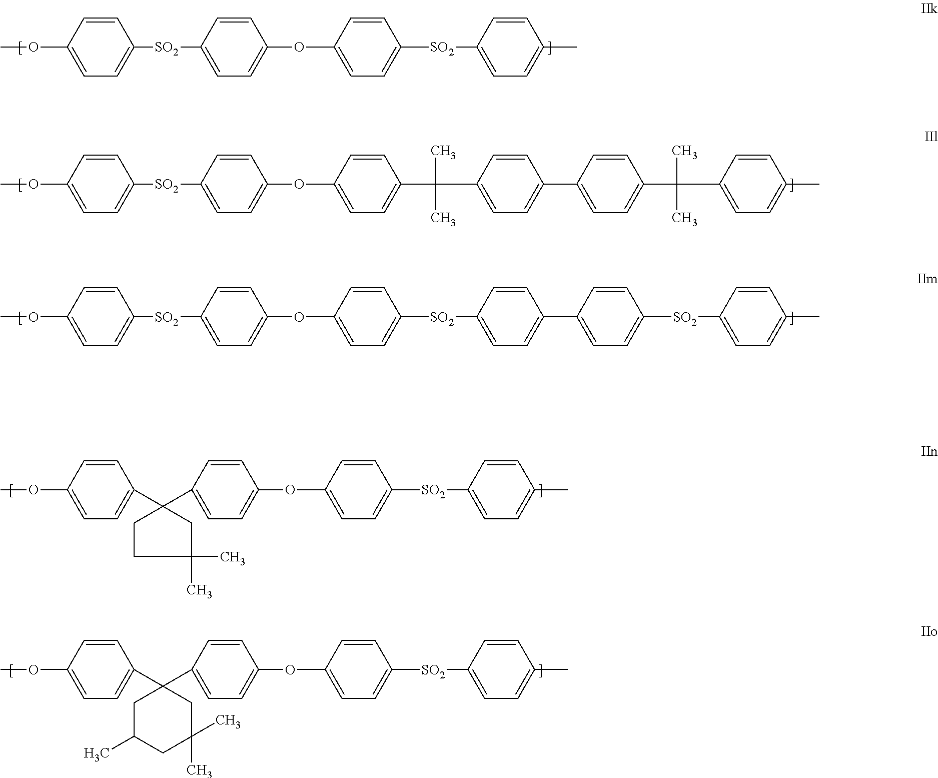

In addition to the units IIa to IIo present with preference, preference is also given to those units in which one or more 1,4-dihydroxyphenyl units are replaced by resorcinol or dihydroxynaphthalene units.

Particularly preferred units (A1) are the units IIa, IIg and IIk. It is also particularly preferred when the unit A1 is formed essentially from one type of units of the general formula II, especially from a unit selected from IIa, IIg and IIk.

In general, the preferred polyarylene ether sulfones (A) have mean molecular weights Mₙ (number-average) in the range from 5000 to 60 000 g/mol and relative viscosities of from 0.20 to 0.95 dl/g. According to the solubility of the polyarylene ether sulfones, the relative viscosities are measured either in 1% by weight N-methylpyrrolidone solution or in mixtures of phenol and dichlorobenzene, at in each case 20° C. or 25° C.

The polyarylene ethers (A) of the present invention preferably have weight-average molecular weights M_{w} of from 10 000 to 150 000 g/mol, especially from 15 000 to 120 000 g/mol, more preferably from 18 000 to 100 000 g/mol, determined by means of gel permeation chromatography in a dimethylformamide solvent against narrow-distribution polymethyl methacrylate as the standard.

The polyarylene ether copolymers of the present invention preferably have viscosity numbers, measured in 1% solution in N-methylpyrrolidone at 25° C., of from 30 to 200 ml/g, especially from 35 to 190 ml/g, more preferably from 40 to 180 ml/g.

In a further embodiment, the inventive polyarylene ethers (A) comprise branching sites of the formula (I) and further branching sites which are derived from crosslinkers CL having at least three hydroxyl functionalities. Such crosslinkers CL have a different structure than that of the formula (I).

When branching sites derived from crosslinkers CL are present, they are preferably present in proportions of from 0.1 to 40% by weight, especially from 0.1 to 10% by weight, in relation to the polyarylene ether (A).

Crosslinkers are added in the course of the polycondensation to prepare the polyaryl ether copolymers, and are incorporated into the main polymer chain like the dihydroxy compounds. By virtue of the crosslinkers CL still having at least one free hydroxyl function, condensation of a suitable monomer with this at least one hydroxyl function results in at least one branch of the main polymer chain. The crosslinkers CL may, in monomeric form, also have four hydroxyl functionalities, such that two hydroxyl functions are still available for branching of the main chain after incorporation into the main polymer chain.

The additional crosslinkers CL mentioned are of course present in polymeric form in the polyarylene ether (A). If such additional crosslinkers CL are present or are used at all, they preferably have a structure which is explained hereinafter:

The crosslinkers CL are preferably aromatic or partly aromatic compounds. Preferred crosslinkers CL have at least three hydroxyl groups bonded to aromatic rings, i.e. they have at least three phenolic hydroxyl groups.

Crosslinkers CL in monomeric form include especially:

phloroglucinol, 4,6-dimethyl-2,4,6-tri(4-hydroxyphenyl)heptene-2 (=trimeric isopropylphenol), 4,6-dimethyl-2,4,6-tri(4-hydroxyphenyl)heptane (=hydrogenated primary isopropenylphenol), 1,3,5-tri(4-hydroxyphenyl)benzene, 1,1,1-tri(4-hydroxyphenyl)ethane and -propane, tetra(4-hydroxyphenyl)methane, 1,4-bis[(4′,4″-dihydroxytriphenyl)methyl]benzene and 2,2-bis[4,4′-bis(4-hydroxyphenyl)cyclohexyl]propane.

Particularly preferred crosslinkers CL are those trihydric or more than trihydric phenols which can be prepared by reaction of p-alkyl-substituted monophenols at unsubstituted positions with formaldehyde or compounds which supply formaldehyde, for example the trisphenol formed from p-cresol and formaldehyde, 2-6-bis(2′-hydroxy-5′-methylbenzyl)-4-methylphenol. Additionally useful as crosslinkers CL are 2,6-bis(2′-hydroxy-5′-isopropylbenzyl)-4-isopropenylphenol and bis[2-hydroxy-3-(2′-hydroxy-5′-methylbenzyl)-5-methylphenyl]methane.

Useful phenols having at least three hydroxyl functionalities also include those which, in addition to the phenolic hydroxyl groups, have halogen atoms, for example the halogenated trihydroxyaryl ethers of the formula (I-a)

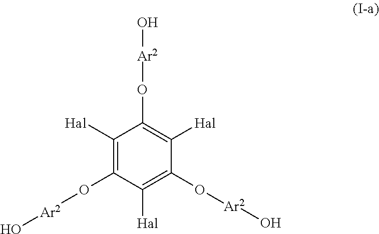

in which Are is a mono- or polycyclic divalent aromatic radical and Hal is chlorine or bromine. Examples of such compounds are:
1,3,5-tris(4-hydroxyphenoxy)-2,4,6-trichlorobenzene,
1,3,5-tris[4-(4-hydroxyphenylisopropyl)phenoxy]-2,4,6-trichlorobenzene,
1,3,5-tris[4-(4-hydroxy)biphenoxy]-2,4,6-trichlorobenzene,
1,3,5-tris[4-(4-hydroxyphenylsulfonyl)phenoxy]-2,4,6-trichlorobenzene and
1,3,5-tris[4-(4-hydroxyphenylisopropyl)phenoxy]-2,4,6-tribromobenzene.

The preparation of the aforementioned compounds is described in German published specification 1 768 620.

In a particularly preferred embodiment, the crosslinker CL is selected from 1,1,1-tris(4-hydroxyphenyl)ethane (I-b)

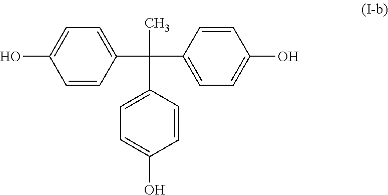

and compounds derived from (I-b). The crosslinker CL is most preferably selected from 1,1,1-tris(4-hydroxyphenyl)ethane (I-b).

The process according to the invention for preparing the inventive polyarylene ethers comprises the reaction of at least one aromatic compound (a1) having two halogen substituents and at least one aromatic compound (a2) having two functional groups reactive toward the aforementioned halogen substituents, in the presence of at least one trifunctional compound of the general formula (III):

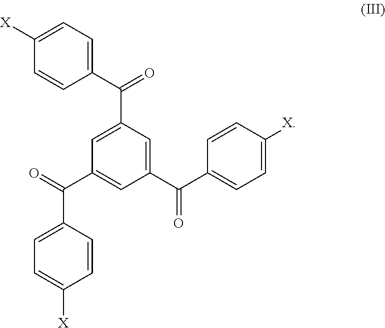

In the context of the general formula (III), each of the three X substituents is independently selected according to the conditions (i) or (ii):
(i) each of the three X substituents is selected independently from O and OH; or
(ii) each of the three X substituents is selected independently from halogen, preferably F and Cl.

In a particularly preferred embodiment, X═F. Such compounds of the general formula (III) are known per se to those skilled in the art or can be prepared by known methods.

Aromatic compounds (a1) and (a2) suitable for the preparation of polyarylene ethers as monomers are known to those skilled in the art and are not subject to any fundamental restriction, provided that the substituents mentioned are sufficiently reactive in a nucleophilic aromatic substitution. A further prerequisite is a sufficient solubility in the solvent, as discussed in detail below.

Suitable compounds (a1) are especially dihalodiphenyl sulfones such as 4,4′-dichlorodiphenyl sulfone, 4,4′-difluorodiphenyl sulfone, 4,4′-dibromodiphenyl sulfone, bis(2-chlorophenyl)sulfones, 2,2′-dichlorodiphenyl sulfone and 2,2′-difluorodiphenyl sulfone.

The aromatic compounds having two halogen substituents (a1) are preferably selected from 4,4′-dihalodiphenyl sulfones, especially 4,4′-dichlorodiphenyl sulfone or 4,4′-difluorodiphenyl sulfone.

The groups reactive toward the aforementioned halogen substituents are especially phenolic OH and O— groups, the latter functional group deriving from the dihydroxyl compounds and being preparable or formed as an intermediate in a known manner from such a compound. Preferred compounds (a2) are accordingly those having two phenolic hydroxyl groups.

Preferred compounds (a2) having two phenolic hydroxyl groups are selected from the following compounds:
dihydroxybenzenes, especially hydroquinone and resorcinol;
dihydroxynaphthalenes, especially 1,5-dihydroxynaphthalene, 1,6-dihydroxynaphthalene, 1,7-dihydroxynaphthalene, and 2,7-dihydroxynaphthalene;
dihydroxybiphenyls, especially 4,4′-biphenol and 2,2′-biphenol;
bisphenyl ethers, especially bis(4-hydroxyphenyl)ether and bis(2-hydroxyphenyl)ether;
bisphenylpropanes, especially 2,2-bis(4-hydroxyphenyl)propane, 2,2-bis(3-methyl-4-hydroxyphenyl)propane and 2,2-bis(3,5-dimethyl-4-hydroxyphenyl)propane;
bisphenylmethanes, especially bis(4-hydroxyphenyl)methane;
bisphenyl sulfones, especially bis(4-hydroxyphenyl)sulfone;
bisphenyl sulfides, especially bis(4-hydroxyphenyl)sulfide;
bisphenyl ketones, especially bis(4-hydroxyphenyl)ketone;
bisphenylhexafluoropropanes, especially 2,2-bis(3,5-dimethyl-4-hydroxyphenyl)hexafluoropropane; and
bisphenylfluorenes, especially 9,9-bis(4-hydroxyphenyl)fluorene.

It is preferred, proceeding from the aforementioned aromatic dihydroxyl compounds (a2), to prepare dipotassium or disodium salts thereof and to react them with the compound (a1). The aforementioned compounds can be used individually or as a combination of two or more of the aforementioned compounds.

Hydroquinone, resorcinol, dihydroxynaphthalene, especially 2,7-dihydroxynaphthalene, 4,4′-dihydroxydiphenyl sulfone and 4,4′-bisphenol, are particularly preferred as the aromatic compound (a2) having two functional groups reactive toward the halogen substituents of the aromatic compound (a1).

The quantitative ratios to be used are calculated from the stoichiometry of the polycondensation reaction which proceeds with theoretical elimination of hydrogen chloride and are established by the person skilled in the art in a known manner.

In the course of performance of the process according to the invention, portions of the halogen groups from the compound (a1) or portions of the groups reactive toward halogen groups in the compound (a2) are replaced by an appropriate trifunctional compound of the general formula (III) as defined above.

The molar ratio of monomers having hydroxyl functionalities to monomers having halogen functionalities is from 0.8:1.2 to 1.2:0.8, preferably from 0.9:1.1 to 1.1:0.9, more preferably 1:1. When different monomers having hydroxyl functionalities or having halogen functionalities are present, the molar amounts are in each case calculated in total.

Particular preference is given to the reaction of the monomers in aprotic polar solvents in the presence of anhydrous alkali metal carbonate, especially sodium or potassium carbonate, calcium carbonate or mixtures thereof, very particular preference being given to potassium carbonate, especially potassium carbonate with a volume-weighted mean particle size of less than 100 micrometers, determined with a particle size measuring instrument in a suspension in N-methylpyrrolidone. A particularly preferred combination is N-methylpyrrolidone as a solvent and potassium carbonate as a base.

The reaction of the suitable monomers is carried out at a temperature of from 80 to 250° C., preferably from 100 to 220° C. The reaction is carried out for from 2 to 12 h, preferably from 3 to 8 h. After the polycondensation reaction has ended, a monofunctional alkyl or aryl halide, for example C₁-C₆-alkyl chloride, bromide or iodide, preferably methyl chloride, or benzyl chloride, bromide or iodide, or mixtures thereof, can be added to the reaction mixture. These compounds react with the hydroxyl groups at the ends of the macromolecules and thus form the start and end pieces of the macromolecules.

Reaction in the melt is likewise possible. Polycondensation in the melt is carried out at a temperature of from 140 to 290° C., preferably from 150 to 280° C.

In a further, likewise preferred variant for preparing the inventive polyarylene ethers (A), prepolymeric arylene ethers which have reactive end groups (so-called telechelics) which are reactive toward the trifunctional compound of the general formula (III) are first prepared in a first step. The variants (i) and (ii) described there can be combined as follows with the reactive end groups of the telechelics:
variant (i): prepolymer with halogen end groups, especially —Cl or —F
variant (ii): prepolymer with OH or O end groups.

The preparation of such telechelics is known to those skilled in the art and preferably proceeds from the above-described compounds (a1) and (a2) through control of the use ratio such that one type of end group which is to function as the end group is present in a molar excess compared to the other end group of from about 1.01:1 to about 1.15:1. In a second step, the telechelics are subsequently reacted with the trifunctional compound of the general formula (III).

The polyarylene ether copolymers are purified by methods known to those skilled in the art, for example recrystallization or washing with suitable solvents in which the inventive polyarylene ether copolymers are preferably for the most part insoluble.

### Thermoplastic Molding Materials

The present invention further provides thermoplastic molding materials comprising at least one of the inventive polyarylene ethers (A) and at least one thermoplastic polymer (B) other than the polyarylene ether (A).

The composition of the inventive thermoplastic molding materials may vary over a wide range, especially since the thermoplastic molding materials, in addition to the thermoplastic polymer (B), optionally comprise further components or can be used directly or as a masterbatch.

Preferred thermoplastic molding materials comprise from 0.1 to 99% by weight of at least one inventive polyarylene ether (A), from 1 to 99.9% by weight of at least one further thermoplastic polymer (B) and optionally from 0 to 70% by weight of at least one fibrous filler (C), where the sum of the percentages by weight of (A), (B) and (C) adds up to 100% by weight.

The thermoplastic polymer (B) is preferably not branched, i.e. is formed from units joined linearly.

The inventive thermoplastic molding materials may optionally especially comprise the following further components: (D) at least one impact-modifying rubber and (E) one or more additives.

In a preferred embodiment, the thermoplastic molding materials of the present invention comprise from 1 to 20% by weight, especially from 3 to 15% by weight, of at least one inventive polyarylene ether (A), from 39 to 99% by weight, especially from 47 to 97% by weight, of at least one further thermoplastic polymer (B), from 0 to 70% by weight, especially from 0 to 50% by weight, of at least one fibrous filler (C), from 0 to 40% by weight of at least one impact-modifying rubber (D) and from 0 to 40% by weight of at least one additive (E), where the sum of the percentages by weight of (A), (B), (C), (D) and (E) adds up to 100% by weight.

The individual components (B) to (E) are explained in detail hereinafter.

### Component B

The thermoplastic molding materials of the present invention preferably comprise, as the thermoplastic polymer (B), at least one polyarylene ether sulfone which is preferably not branched. Preferred polyarylene ether sulfones as component (B) thus differ from the corresponding polyarylene ethers (A) preferably in that they are not branched but are formed from units joined linearly.

Preferred polyarylene ether sulfones have the units (A1) which have already been described in the context of the branched polyarylene ethers (A). Preferred polyarylene ether sulfones as component (B) thus differ from the corresponding polyarylene ethers (A) preferably in that they are not branched but are formed from units joined linearly.

Preference is given to thermoplastic molding materials which comprise, as the thermoplastic polymer (B), at least one polyarylene ether sulfone based on units of the general formula (IV):

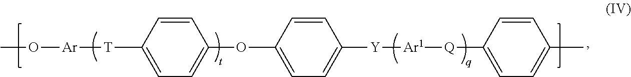

where t, q, Q, T, Y, Ar and Ar¹ are each defined as follows:
t, q: each independently 0, 1, 2 or 3,
Q, T, Y: each independently a chemical bond or a group selected from —O—, —S—, —SO₂—, S═O, C═O, —N═N—, —CR^{a}R^{b}—, where R^{a} and R^{b} are each independently a hydrogen atom or a C₁-C₁₂-alkyl, C₁-C₁₂-alkoxy or C₆-C₁₈-aryl group, where at least one of Q, T and Y is different than —O—, and at least one of Q, T and Y is —SO₂—, and
Ar, Ar¹: each independently a C₆-C₁₈-arylene group.

Preferably, Q, T and Y in formula (IV) are each independently selected from —O— and —SO₂—, where at least one of the group consisting of Q, T and Y is —SO₂—.

R^{a} and R^{b} are each defined as described in the context of the polyarylene ethers (A).

Ar and Ar¹ are each independently a C₆-C₁₈-arylene group. Proceeding from the starting materials described below, Ar is preferably derived from an electron-rich, readily electrophilically attackable aromatic substance which is preferably selected from the group consisting of hydroquinone, resorcinol, dihydroxynaphthalene, especially 2,7-dihydroxynaphthalene, and 4,4′-bisphenol. Ar¹ is preferably an unsubstituted C₆- or C₁₂-arylene group.

Useful C₆-C₁₈-arylene groups Ar and Ar¹ are especially phenylene groups, such as 1,2-, 1,3- and 1,4-phenylene, naphthylene groups, for example 1,6-, 1,7-, 2,6- and 2,7-naphthylene, and the arylene groups derived from anthracene, phenanthrene and naphthacene.

Ar and Ar¹ in the preferred embodiment of the formula (II) are preferably each independently selected from the group consisting of 1,4-phenylene, 1,3-phenylene, naphthylene, especially 2,7-dihydroxynaphthylene, and 4,4′-bisphenylene.

Preferred units of the formula (IV) are those which are formed on the basis of at least one of the repeating structural units IIa to IIo described in the context of component (A1).

In addition to the units IIa to IIo which are present with preference, preference is also given to those units in which one or more 1,4-dihydroxyphenyl units are replaced by resorcinol or dihydroxynaphthalene units.

Particularly preferred units of the formula (IV) are the units IIa, IIg and IIk. In a particularly preferred embodiment, the thermoplastic polymer (B) is formed from units which are selected from IIa, IIg and IIk. Homopolymers of polyarylene ether sulfones are particularly preferred.

When the thermoplastic polymer (B) is a polyarylene ether, component (B) preferably has a weight-average molecular weight M_{w} of from 10 000 to 150 000 g/mol, especially from 15 000 to 120 000 g/mol, more preferably from 18 000 to 100 000 g/mol, determined by means of gel permeation chromatography in a dimethylformamide solvent against narrow-distribution polymethyl methacrylate as a standard.

The polyarylene ethers preferred as the thermoplastic polymer (B) preferably have viscosity numbers, measured in 1% solution in N-methylpyrrolidone at 25° C., of from 30 to 200 ml/g, especially from 35 to 190 ml/g, more preferably from 40 to 180 ml/g.

In general, the polyarylene ether sulfones preferred as the thermoplastic polymer (B) have mean molecular weights Mn (number average) in the range from 5000 to 60 000 g/mol and relative viscosities of from 0.20 to 0.95 dl/g. According to the solubility of the polyarylene ether sulfones, the relative viscosities are measured either in 1% by weight N-methylpyrrolidone solution or in mixtures of phenol and dichlorobenzene at in each case 20° C. or 25° C.

The abovementioned thermoplastic polymers (B) and the preparation thereof are known to those skilled in the art.

### Component C

The inventive molding materials may comprise fibrous additives.

In a first preferred embodiment, the inventive molding materials comprise fibrous additives, especially glass fibers.

The thermoplastic molding materials preferably comprise from 1 to 59% by weight of at least one polyarylene ether (A) comprising units (II) as defined in the context of component (A), from 40 to 98% by weight of at least one thermoplastic polymer (B) and from 1 to 59% by weight of fibrous fillers, wherein the thermoplastic polymer (B) is a polyarylene ether sulfone comprising units (IV) as defined above, with the proviso that the units (IV) and (II) are the same or different.

Preferred fibrous fillers or reinforcing agents are carbon fibers, potassium titanate whiskers, aramide fibers and more preferably glass fibers. In the case of use of glass fibers, these may be modified with a size, preferably a polyurethane size and an adhesion promoter, for better compatibility with the matrix material. In general, the carbon and glass fibers used have a diameter in the range from 6 to 20 μm.

The glass fibers can be incorporated either in the form of short glass fibers or in the form of endless strands (rovings). In the finished injection molding, the mean length of the glass fibers is preferably in the range from 0.08 to 0.5 mm.

Carbon or glass fibers can also be used in the form of fabrics, mats or fiberglass rovings.

Suitable particulate fillers include amorphous silica, carbonates such as magnesium carbonate (chalk), powdered quartz, mica, a wide variety of different silicates such as clays, muscovite, biotite, suzorite, tin maletite, talc, chlorite, phlogophite, feldspar, calcium silicates such as wollastonite, or aluminum silicates such as kaolin, particularly clacined kaolin.

In a particularly preferred embodiment, particulate fillers are used, of which at least 95% by weight, preferably at least 98% by weight, of the particles have a diameter (greatest dimension), determined on the finished product, of less than 45 μm, preferably less than 40 μm, and whose aspect ratio is in the range from 1 to 25, preferably in the range from 2 to 20, determined on the finished product.

The particle diameters can be determined, for example, by recording electron micrographs of thin sections of the polymer mixture and employing at least 25, preferably at least 50, filler particles for the evaluation. The particle diameter can likewise be determined by means of sedimentation analysis, according to Transactions of ASAE, page 491 (1983). The proportion by weight of the fillers less than 40 μm can also be determined by means of screen analysis. The aspect ratio is the ratio of particle diameter to thickness (greatest dimension to smallest dimension).

Particularly preferred particulate fillers are talc, kaolin, such as calcined kaolin or wollastonite, or mixtures of two or all of these fillers. Among these, particular preference is given to talc with a proportion of at least 95% by weight of particles having a diameter of less than 40 μM and an aspect ratio of from 1.5 to 25, in each case determined on the finished product. Kaolin preferably has a proportion of at least 95% by weight of particles having a diameter of less than 20 μm and an aspect ratio of from 1.2 to 20, in each case determined on the finished product.

In a further preferred embodiment, the inventive molding materials do not comprise any fibrous additives.

In this further preferred embodiment, the thermoplastic molding materials comprise from 1 to 60% by weight of at least one polyarylene ether (A) comprising units (II) as defined in the context of component (A), from 40 to 98% by weight of at least one thermoplastic polymer (B), but no fibrous fillers, wherein the thermoplastic polymer (B) is a polyarylene ether sulfone comprising units (IV) as defined above, with the proviso that the aforementioned units (IV) and (II) are the same.

### Component D

In a particularly preferred embodiment, the thermoplastic molding materials may comprise at least one rubber to increase the toughness.

In the context of the present invention, rubber is understood to mean a crosslinked polymeric compound which has elastomeric properties.

The proportion of component (D) in the inventive thermoplastic molding materials may vary within wide ranges. Preferred inventive molding materials comprise component (D) in amounts of from 0 to 30 and especially from 0 to 20% by weight, based on the total weight of components (A) to (F). Particularly preferred molding materials comprise from 0 to 17.5% by weight, based on the total weight of components (A) to (F).

The components D used may also be mixtures of two or more different rubbers.

Preferred rubbers which increase the toughness of the molding materials especially have two essential features: they comprise an elastomeric fraction which has a glass transition temperature of less than −10° C., preferably of less than −30° C., and they comprise at least one functional group which can interact with component (A) and/or component (B). Suitable functional groups are especially carboxylic acid, carboxylic anhydride, carboxylic ester, carboxamide, carboximide, amino, hydroxyl, epoxy, urethane or oxazoline groups.

Preference is given to using at least one functionalized rubber as component D. The preferred functionalized rubbers include functionalized polyolefin rubbers which are formed from the following monomer components:
d1) from 40 to 99% by weight of at least one alpha-olefin having from 2 to 8 carbon atoms;
d2) from 0 to 50% by weight of a diene;
d3) from 0 to 45% by weight of a C₁-C₁₂-alkyl ester of acrylic acid or methacrylic acid or mixtures of such esters;
d4) from 0 to 40% by weight of an ethylenically unsaturated C₂-C₂₀-mono- or dicarboxylic acid or a functional derivative of such an acid;
d5) from 1 to 40% by weight of a monomer comprising epoxy groups; and
d6) from 0 to 5% by weight of other free-radically polymerizable monomers.

Examples of suitable alpha-olefins as monomer component d1) may be ethylene, propylene, 1-butylene, 1-pentylene, 1-hexylene, 1-heptylene, 1-octylene, 2-methylpropylene, 3-methyl-1-butylene and 3-ethyl-1-butylene, preference being given to ethylene and propylene.

Suitable diene monomers d2) include, for example, conjugated dienes having from 4 to 8 carbon atoms, such as isoprene and butadiene, nonconjugated dienes having from 5 to 25 carbon atoms, such as penta-1,4-diene, hexa-1,4-diene, hexa-1,5-diene, 2,5-dimethylhexa-1,5-diene and octa-1,4-diene, cyclic dienes such as cyclopentadiene, cyclohexadienes, cyclooctadienes and dicyclopentadiene, and alkenylnorbornenes such as 5-ethylidene-2-norbornene, 5-butylidene-2-norbornene, 2-methallyl-5-norbornene, 2-isopropenyl-5-norbornene and tricyclodienes, such as 3-methyltricyclo-[5.2.1.0.2.6]-3,8-decadiene, or mixtures thereof. Preference is given to hexa-1,5-diene, 5-ethylidenenorbornene and dicyclopentadiene. The diene content is preferably from 0.5 to 50, especially from 2 to 20 and more preferably from 3 to 15% by weight, based on the total weight of the monomer components (d1) to (d6).

Examples of suitable esters as monomer component d3) are especially methyl, ethyl, propyl, n-butyl, i-butyl and 2-ethylhexyl, octyl and decyl acrylates, or the corresponding esters of methacrylic acid. Among these, particular preference is given to methyl, ethyl, propyl-, n-butyl and 2-ethylhexyl acrylate and methacrylate.

Instead of the esters d3) or in addition thereto, the olefin polymers may also comprise acid-functional and/or latently acid-functional monomers of ethylenically unsaturated mono- or dicarboxylic acids d4).

Examples of monomers d4) include especially acrylic acid, methacrylic acid, tertiary alkyl esters of these acids, especially tert-butyl acrylate, and dicarboxylic acids such as maleic acid and fumaric acid, or derivatives of these acids and monoesters thereof.

Latently acid-functional monomers shall be understood to mean those compounds which form free acid groups under the polymerization conditions or in the course of incorporation of the olefin polymers into the molding materials. Examples thereof are especially anhydrides of dicarboxylic acids having from 2 to 20 carbon atoms, especially maleic anhydride, and tertiary C₁-C₁₂-alkyl esters of the aforementioned acids, especially tert-butyl acrylate and tert-butyl methacrylate.

Preferred ethylenically unsaturated dicarboxylic acids and anhydrides as monomer component d4) are represented by the following general formulae V and VI:

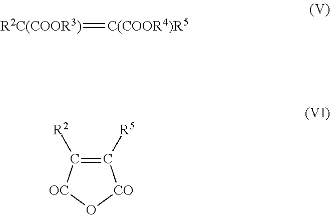

in which R², R³, R⁴ and R⁵ are each independently H or C₁-C₆-alkyl.

Preferred monomers d5) which bear epoxy groups are represented by the following general formulae VII and VIII

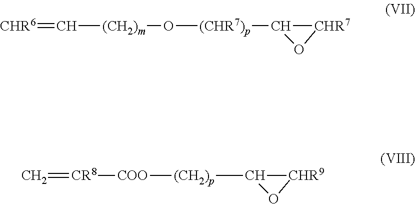

in which R⁶, R⁷, R⁸ and R⁹ are each independently H or C₁-C₆-alkyl, m is an integer from 0 to 20 and p is an integer from 0 to 10.

Preferably, R² to R⁹ are each hydrogen, m is 0 or 1 and p is 1.

Preferred compounds d4) and d5) are, respectively, maleic acid, fumaric acid and maleic anhydride, and alkenyl glycidyl ether and vinyl glycidyl ether.

Particularly preferred compounds of the formulae V and VI, and VII and VIII, are, respectively, maleic acid and maleic anhydride, and epoxy group-containing esters of acrylic acid and/or methacrylic acid, especially glycidyl acrylate and glycidyl methacrylate.

Particular preference is given to olefin polymers which are formed from 50 to 98.9 and especially 60 to 94.85% by weight of ethylene, and from 1 to 50 and especially 5 to 40% by weight of an ester of acrylic or methacrylic acid, from 0.1 to 20.0 and especially from 0.15 to 15% by weight of glycidyl acrylate and/or glycidyl methacrylate, acrylic acid and/or maleic anhydride.

Particularly suitable functionalized rubbers B are ethylene-methyl methacrylate-glycidyl methacrylate, ethylene-methyl acrylate-glycidyl methacrylate, ethylene-ethyl acrylate-glycidyl acrylate and ethylene-methyl methacrylate-glycidyl acrylate polymers.

Useful other monomers d6) include, for example, vinyl esters and vinyl ethers.

The above-described polymers can be prepared by processes known per se, preferably by random copolymerization under high pressure and elevated temperature.

The melt index of component (D) is generally in the range from 1 to 80 g/10 min (measured at 190° C. and load 2.16 kg).

A further group of suitable rubbers (D) is that of core-shell graft rubbers. These are graft rubbers which are prepared in emulsion and consist of at least one hard and one soft constituent. A hard constituent is typically understood to mean a polymer with a glass transition temperature of at least 25° C., and a soft constituent to mean a polymer with a glass transition temperature of at most 0° C. These products have a structure composed of a core and at least one shell, the structure arising through the sequence of monomer addition. The soft constituents derive generally from butadiene, isoprene, alkyl acrylates, alkyl methacrylates or siloxanes and optionally further comonomers. Suitable siloxane cores can be prepared, for example, proceeding from cyclic oligomeric octamethyltetrasiloxane or tetravinyltetramethyltetrasiloxane. These can be reacted, for example, with gamma-mercaptopropylmethyldimethoxysilane in a ring-opening cationic polymerization, preferably in the presence of sulfonic acids, to give the soft siloxane cores. The siloxanes can also be crosslinked by, for example, performing the polymerization reaction in the presence of silanes having hydrolyzable groups such as halogen or alkoxy groups, such as tetraethoxysilane, methyltrimethoxysilane or phenyltrimethoxysilane. Suitable comonomers here are, for example, styrene, acrylonitrile and crosslinking or graft-active monomers with more than one polymerizable double bond, such as diallyl phthalate, divinylbenzene, butanediol diacrylate or triallyl(iso)cyanurate. The hard constituents derive generally from styrene, alpha-methylstyrene and copolymers thereof, the comonomers here preferably including acrylonitrile, methacrylonitrile and methyl methacrylate.

Preferred core-shell graft rubbers comprise a soft core and a hard shell or a hard core, a first soft shell and at least one further hard shell. Functional groups such as carbonyl, carboxylic acid, acid anhydride, acid amide, acid imide, carboxylic ester, amino, hydroxyl, epoxy, oxazoline, urethane, urea, lactam or halobenzyl groups are incorporated here preferably through the addition of suitably functionalized monomers in the polymerization of the last shell. Suitable functionalized monomers are, for example, maleic acid, maleic anhydride, mono- or diesters of maleic acid, tert-butyl (meth)acrylate, acrylic acid, glycidyl (meth)acrylate and vinyloxazoline. The proportion of monomers with functional groups is generally from 0.1 to 25% by weight, preferably from 0.25 to 15% by weight, based on the total weight of the core-shell graft rubber. The weight ratio of soft to hard constituents is generally from 1:9 to 9:1, preferably from 3:7 to 8:2.

Rubbers of this kind are known per se and are described, for example, in EP-A 208 187.

A further group of suitable impact modifiers is that of thermoplastic polyester elastomers. Polyester elastomers are understood to mean segmented copolyether esters which comprise long-chain segments which generally derive from poly(alkylene) ether glycols and short-chain segments which derive from low molecular weight diols and dicarboxylic acids. Products of this kind are known per se and are described in the literature, for example in U.S. Pat. No. 3,651,014. Corresponding products are also commercially available under the names Hytrel™ (Du Pont), Arnitel™ (Akzo) and Pelprene™ (Toyobo Co. Ltd.).

It will be appreciated that it is also possible to use mixtures of different rubbers.

### Component E

The inventive molding materials may comprise, as a further component E, assistants, especially processing assistants, pigments, stabilizers, flame retardants or mixtures of different additives. Customary additives are, for example, also oxidation retardants, stabilizers to thermal decomposition and decomposition through ultraviolet light, lubricants and demolding agents, dyes and plasticizers.

The proportion of component (E) in the inventive molding material is especially from 0 up to 30 and preferably from 0 up to 20% by weight, especially from 0 to 15% by weight, based on the total weight of components A to E. In the case that component E comprises stabilizers, the proportion of these stabilizers is typically up to 2% by weight, preferably from 0.01 to 1% by weight, especially from 0.01 to 0.5% by weight, based on the sum of the percentages by weight of components (A) to (E).

Pigments and dyes are generally present in amounts of from 0 to 6, preferably from 0.05 to 5 and especially from 0.1 to 3% by weight, based on the sum of the percentages by weight of components (A) to (E).

The pigments for coloring thermoplastics are common knowledge; see, for example, R. Gächter and H. Müller, Taschenbuch der Kunststoffadditive [Handbook of Plastics Additives], Carl Hanser Verlag, 1983, pages 494 to 510. The first preferred group of pigments is that of white pigments, such as zinc oxide, zinc sulfide, lead white [2PbCO₃.Pb(OH)₂], Ilithopones, antimony white and titanium dioxide. Among the two most commonly used crystal polymorphs (rutile and anatase type) of titanium dioxide, especially the rutile form is used to whiten the inventive molding materials. Black color pigments which can be used in accordance with the invention are iron oxide black (Fe₃O₄), spinel black [Cu(Cr,Fe)₂O₄], manganese black (mixture of manganese dioxide, silicon dioxide and iron oxide), cobalt black and antimony black, and more preferably carbon black, which is usually used in the form of furnace black or gas black; on this subject, see G. Benzing, Pigmente für Anstrichmittel [Pigments for Paints], Expert-Verlag (1988), pages 78 ff.

To establish particular hues, inorganic chromatic pigments, such as chromium oxide green, or organic chromatic pigments, such as azo pigments or phthalocyanines, can be used in accordance with the invention. Such pigments are generally commercially available.

Oxidation retardants and thermal stabilizers which can be added to the thermoplastic materials in accordance with the invention are, for example, halides of metals of group (I) of the Periodic Table, for example sodium, potassium and lithium halides, for example chlorides, bromides or iodides. In addition, it is possible to use zinc fluoride and zinc chloride. Additionally usable are sterically hindered phenols, hydroquinones, substituted representatives of this group, secondary aromatic amines, optionally in combination with phosphorus acids or salts thereof, and mixtures of these compounds, preferably in concentrations up to 1% by weight, based on the sum of the percentage by weight of components (A) to (E).

Examples of UV stabilizers are various substituted resorcinols, salicylates, benzotriazoles and benzophenones, which are generally used in amounts up to 2% by weight.

Lubricants and demolding agents, which are generally added in amounts up to 1% by weight based on the sum of the % by weight of components (A) to (E), are stearyl alcohol, alkyl stearates and stearamides, and also esters of pentaerythritol with long-chain fatty acids. It is also possible to use dialkyl ketones, for example distearyl ketone.

As a preferred constituent, the inventive molding materials comprise from 0.1 to 2, preferably from 0.1 to 1.75 and more preferably from 0.1 to 1.5% by weight, and especially from 0.1 to 0.9% by weight (based on the sum of the % by weight of components (A) to (E)), of stearic acid and/or stearates. In principle, it is also possible to use other stearic acid derivatives, such as esters of stearic acid.

Stearic acid is preferably prepared by hydrolysis of fats. The resulting products are typically mixtures of stearic acid and palmitic acid. Such products therefore have a wide softening range, for example from 50 to 70° C., according to the composition of the product. Preference is given to using products with a proportion of stearic acid of more than 20 and more preferably more than 25% by weight. It is also possible to use pure stearic acid (>98%).

In addition, it is also possible to use stearates as component C. Stearates can be prepared either by reacting appropriate sodium salts with metal salt solutions (for example CaCl₂, MgCl₂, aluminum salts . . . ) or by directly reacting the fatty acid with metal hydroxide (see, for example, Baerlocher Additives, 2005). Preference is given to using aluminum tristearate.

The sequence in which components (A) to (E) are mixed is as desired.

The inventive molding materials can be prepared by processes known per se, for example extrusion. The inventive molding materials can be prepared, for example, by mixing the starting components in customary mixing apparatus, such as screw extruders, preferably twin-screw extruders, Brabender mixers or Banbury mixers and kneaders, and then extruding. After the extrusion, the extrudate is cooled and comminuted. The sequence of mixing of the components can be varied; for instance, it is possible to premix two or optionally three components, but it is also possible to mix all components together.

In order to obtain very homogeneous mixing, intensive mixing is advantageous. For this purpose, mean mixing times of from 0.2 to 30 minutes at temperatures of from 280 to 380° C., preferably from 290 to 370° C., are generally required. After the extrusion, the extrudate is generally cooled and comminuted.

The inventive molding materials are notable for good mechanical properties, improved flowability compared to the prior art, and improved stress cracking resistance.

The inventive molding materials are notable for good flowability, improved toughness, in particular elongation at break and notched impact resistance, and for an improved surface quality. The inventive molding materials are therefore suitable for producing moldings for domestic articles, electric or electronic components, and for moldings for the vehicle sector.

The inventive thermoplastic molding materials can advantageously be used to produce moldings, fibers, films or foils or foams.

The present invention further provides moldings which are obtainable from the inventive thermoplastic molding materials. Corresponding molding processes are known to those skilled in the art.

The examples which follow illustrate the invention, without restricting it.

### EXAMPLES

The viscosity number of the polyarylene ethers was determined in 1% solution of N-methylpyrrolidone at 25° C. to ISO 1628.

### Preparation and Testing of the Molding Materials

The heat distortion resistance of the samples was determined by means of the Vicat softening temperature. The Vicat softening temperature was determined to DIN 53 460, with a force of 49.05 N and a temperature rise of 50 K per hour, on standard small specimens.

The impact resistance (an) of the reinforced products was determined on ISO specimens to ISO 179 1eU. In the case of unreinforced products, the notched impact resistance (ak) to ISO 179 1eA was used to characterize the toughness.

The flowability was assessed using the melt viscosity.

The melt viscosity was determined by means of a capillary rheometer. This determined the apparent viscosity at 350 or 380° C. as a function of the shear rate.

The stress cracking resistance was determined to DIN EN ISO 22088-3 on specimens of thickness 2 mm. At a flexural strain of 1.32%, the test medium was allowed to act for different periods and the condition of the specimen was subsequently assessed visually.

In the testing of the unreinforced samples, toluene was allowed to act on the specimen for one hour. In the case of the reinforced specimens, the fuel FAM B was allowed to act on the specimen at 80° C. for 7 days.

The condition of the samples was subsequently assessed visually:

+: unchanged
+/−: slight cloudiness, no detectable cracks
−: severe cloudiness, clearly perceptible cracks
−−: fracture of the sample
n.d.: not determined

Component B1: the polyarylene ether B1 used was Ultrason® E 2010 (commercial product of BASF SE). This product is characterized by a viscosity number of 54 ml/g, measured in 1% NMP solution at 25° C.

Component B2: the polyarylene ether B2 used was Ultrason® P 3010 (commercial product of BASF SE). This product is characterized by a viscosity number of 75 ml/g, measured in 1% NMP solution at 25° C.

Component AV: branched polyarylene ether, obtained by nucleophilic aromatic polycondensation of 107.22 g of dichlorodiphenyl sulfone, 90.06 g of dihydroxydiphenyl sulfone, 8.27 g of 1,1,1-tris(4-hydroxyphenyl)ethane under the action of 54.73 g of potassium carbonate in 360 ml of NMP. This mixture is kept at 195° C. for 4 hours. After cooling to 120° C., methyl chloride is introduced into the solution for one hour. After cooling to room temperature, the solid constituents are removed by filtration and the polymer is isolated by precipitation in 1/9 NMP/water. After careful washing with water, the product is dried under reduced pressure at 120° C. for 12 h. The viscosity number of the product was 25.6 ml/g, the glass transition temperature 189° C.

Component A1: branched polyarylene ether, obtained by nucleophilic aromatic polycondensation of 94.90 g of difluorodiphenyl sulfone, 90.06 g of dihydroxydiphenyl sulfone, 12.00 g of 1,3,5-tris(4-fluorophenyl)carbonyl)benzene under the action of 54.73 g of potassium carbonate in 360 ml of NMP. This mixture is kept at 180° C. for 4 hours. After cooling to 120° C., methyl chloride is introduced into the solution for one hour. After cooling to room temperature, the solid constituents are removed by filtration and the polymer is isolated by precipitation in 1/9 NMP/water. After careful washing with water, the product is dried under reduced pressure at 120° C. for 12 h. The viscosity number of the product was 24.6 ml/g, the glass transition temperature 194° C.

Component A2: branched polyarylene ether, obtained by nucleophilic aromatic polycondensation of 86.39 g difluorodiphenyl sulfone, 85.06 g of dihydroxydiphenyl sulfone, 15.11 g of 1,3,5-tris(4-fluorophenyl)carbonyl)benzene under the action of 51.69 g of potassium carbonate in 340 ml of NMP. This mixture is kept at 180° C. for 4 hours. After cooling to 120° C., methyl chloride is introduced into the solution for one hour. After cooling to room temperature, the solid constituents are removed by filtration and the polymer is isolated by precipitation in 1/9 NMP/water. After careful washing with water, the product is dried under reduced pressure at 120° C. for 12 h. The viscosity number of the product was 26.1 ml/g, the glass transition temperature 192° C.

Component C1: chopped glass fibers with polyurethane size, fiber diameter 10 μm.

The components were mixed in a twin-shaft extruder at a material temperature of 350 or 370° C. The melt was passed through a waterbath and granulated.

The molding materials comprising polyether sulfone were processed at 340° C. The mold temperature was in each case 140° C. The molding materials comprising PPSU were processed at material temperature 370° C. and mold temperature 140° C.

The results of the tests are listed in table 1.

TABLE 1

| | Molding material | | | | | | | | | |
|---|---|---|---|---|---|---|---|---|---|---|
| | V1 | V2 | 3 | 4 | V5 | V6 | 7 | V8 | V9 | 10 |
| B1 | 100 | 97.5 | 97.5 | 97.5 | — | — | — | 70 | 68.25 | 68.25 |
| B2 | — | — | — | — | 100 | 97.5 | 97.5 | — | — | — |
| AV | — | 2.5 | — | — | — | 2.5 | — | — | 1.75 | — |
| A1 | — | — | 2.5 | — | — | — | 2.5 | — | — | 1.75 |
| A2 | — | — | — | 2.5 | — | — | — | — | — | — |
| C1 | — | — | — | — | — | — | — | 30 | 30 | 30 |
| Vicat B | 224 | 223 | 223 | 223 | 222 | 222 | 222 | 226 | 226 | 226 |
| [° C.] | | | | | | | | | | |
| an | — | — | — | — | — | — | — | 50.0 | 48.1 | 49.9 |
| [kJ/m²] | | | | | | | | | | |
| ak | 6.9 | 7.1 | 7.2 | 7.0 | 67.2 | 62.4 | 67.1 | 8.3 | 8.4 | 8.3 |
| [kJ/m²] | | | | | | | | | | |
| η at 350° C. | | | | | | | | | | |
| in Pa * s | | | | | | | | | | |
| 100 Hz | 1000 | 870 | 780 | 760 | — | — | — | 1530 | 1370 | 1250 |
| 1000 Hz | 550 | 490 | 440 | 425 | — | — | — | 677 | 590 | 510 |
| η at 380° C. | | | | | | | | | | |
| in Pa * s | | | | | | | | | | |
| 100 Hz | — | — | — | — | 1340 | 1260 | 1160 | — | — | — |
| 1000 Hz | — | — | — | — | 600 | 540 | 480 | — | — | — |
| Stress cracking | — | — | +/− | +/− | n.d. | n.d. | n.d. | — | +/− | + |
| resistance | | | | | | | | | | |

The inventive thermoplastic molding materials have improved flowability. These products surprisingly also feature better stress cracking resistance.

1.-19. (canceled)

20. A polyarylene ether (A) comprising branching sites of the formula (I):

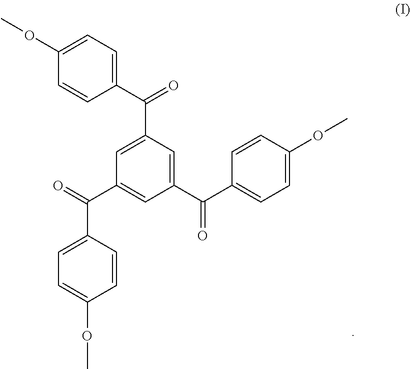

21. The polyarylene ether (A) according to claim 20, which is a polyarylene ether sulfone.

22. The polyarylene ether (A) according to claim 20, comprising
(A1) from 0.1 to 99.9% by weight of at least one unit of the general formula (II) 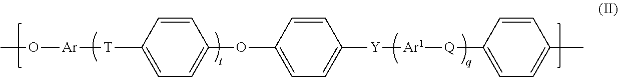
where
t and q: each independently 0, 1, 2 or 3,
Q, T and Y: each independently a chemical bond or a group selected from —O—, —S—, —SO₂—, S═O, C═O, —N═N—, —CR^{a}R^{b}—, where R^{a} and R^{b} are each independently a hydrogen atom or a C₁-C₁₂-alkyl, C₁-C₁₂-alkoxy or C₆-C₁₈-aryl group, where at least one of Q, T and Y is different than —O—, and at least one of Q, T and Y is —SO₂—, and
Ar and Ar¹: each independently a C₆-C₁₈-arylene group,
and
(A2) from 0.1 to 99.9% by weight of branching sites of the formula (I), where the sum of the percentages by weight of (A1) and (A2) adds up to 100% by weight.

23. The polyarylene ether according to claim 22, wherein Q, T and Y in formula (II) are each independently selected from O and SO₂ and at least one of Q, T and Y is SO₂.

24. The polyarylene ether according to claim 22, wherein Ar and Ar¹ in formula (II) are each independently selected from the group consisting of 1,4-phenylene, 1,3-phenylene, naphthylene and 4,4′-bisphenylene.

25. A process for preparing polyarylene ethers according to claim 20 which comprises reacting at least one aromatic compound having two halogen substituents and at least one aromatic compound having two functional groups reactive toward aforementioned halogen substituents, which comprises additionally using at least one trifunctional compound of the general formula (III): 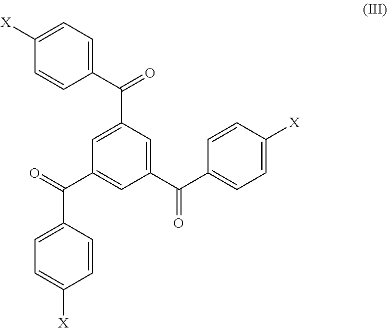
wherein each of the three X substituents is independently selected according to the conditions (i) or (ii):
(i) each of the three X substituents is selected independently from O and OH; or
(ii) each of the three X substituents is selected independently from halogen.

26. The process for preparing polyarylene ethers according to claim 25, wherein each of the three X substituents is F or Cl.

27. The process for preparing polyarylene ethers according to claim 25, wherein the aromatic compounds having two functional groups reactive toward aforementioned halogen substituents are hydroquinone, resorcinol, dihydroxynaphthalene, 4,4′-dihydroxydiphenyl sulfone or 4,4′-bisphenol.

28. The process for preparing polyarylene ethers according to claim 25, wherein the aromatic compounds having two halogen substituents are selected from dihalodiphenyl sulfones.

29. A thermoplastic molding material comprising at least one polyarylene ether (A) according to claim 20.

30. The thermoplastic molding material according to claim 29, comprising from 0.1 to 99% by weight of at least one polyarylene ether (A), from 0.1 to 99% by weight of at least one thermoplastic polymer (B) other than (A), and optionally from 0 to 70% by weight of at least one fibrous filler (C), where the sum of the percentages by weight of (A), (B) and (C) adds up to 100% by weight.

31. The thermoplastic molding material according to claim 30, wherein the fibrous filler present is from 0 to 70% by weight of glass fibers.

32. The thermoplastic molding material according to claims 29, comprising, as the thermoplastic polymer (B), at least one polyarylene ether sulfone.

33. The thermoplastic molding material according to claims 29, comprising, as the thermoplastic polymer (B), at least one polyarylene ether sulfone based on units of the general formula (IV): 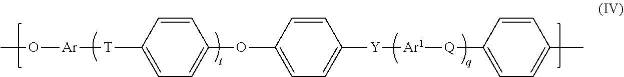
wherein
t and q: each independently 0, 1, 2 or 3,
Q, T and Y: each independently a chemical bond or a group selected from —O—, —S—, —SO₂—, S═O, C═O, —N═N—, and —CR^{a}R^{b}—, where R^{a} and R^{b} are each independently a hydrogen atom or a C₁-C₁₂-alkyl, C₁-C₁₂-alkoxy or C₆-C₁₈-aryl group, where at least one of Q, T and Y is different than —O—, and at least one of Q, T and Y is —SO₂—, and
Ar and Ar¹: each independently a C₆-C₁₈-arylene group.

34. The thermoplastic molding material according to claim 33, wherein Q, T and Y in formula (IV) are each independently selected from O and SO₂ and at least one of Q, T and Y is SO₂.

35. The thermoplastic molding material according to claim 32, wherein Ar and Ar¹ in formula (IV) are each independently selected from the group consisting of 1,4-phenylene, 1,3-phenylene, naphthylene and 4,4′-bisphenylene.

36. The thermoplastic molding material according to claim 33, comprising from 1 to 59% by weight of at least one polyarylene ether (A) comprising units (II) 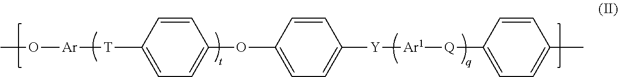
where
t and q: each independently 0, 1, 2 or 3,
Q, T and Y: each independently a chemical bond or a group selected from —O—, —S—, —SO₂—, S═O, C═O, —N═N—, —CR^{a}R^{b}—, where R^{a} and R^{b} are each independently a hydrogen atom or a C₁-C₁₂-alkyl, C₁-C₁₂-alkoxy or C₆-C₁₈-aryl group, where at least one of Q, T and Y is different than —O—, and at least one of Q, T and Y is —SO₂—, and
Ar and Ar¹: each independently a C₆-C₁₈-arylene group,
from 40 to 98% by weight of at least one thermoplastic polymer (B) and
from 1 to 59% by weight of fibrous fillers, wherein the thermoplastic polymer (B) is a polyarylene ether sulfone comprising units (IV) as defined in claim 33, with the proviso that the units (IV) and (II) are the same or different.

37. The thermoplastic molding material according to claim 33, comprising from 1 to 60% by weight of at least one polyarylene ether (A) comprising units (II) 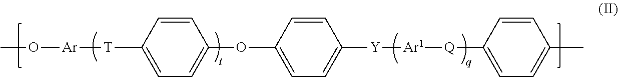
where
t and q: each independently 0, 1, 2 or 3,
Q, T and Y: each independently a chemical bond or a group selected from —O—, —S—, —SO₂—, S═O, C═O, —N═N—, —CR^{a}R^{b}—, where R^{a} and R^{b} are each independently a hydrogen atom or a C₁-C₁₂-alkyl, C₁-C₁₂-alkoxy or C₆-C₁₈-aryl group, where at least one of Q, T and Y is different than —O—, and at least one of Q, T and Y is —SO₂—, and
Ar and Ar¹: each independently a C₆-C₁₈-arylene group,
from 40 to 99% by weight of at least one thermoplastic polymer (B),
but no fibrous fillers,
wherein the thermoplastic polymer (B) is a polyarylene ether sulfone comprising units (IV) as defined in claim 33, with the proviso that the aforementioned units (IV) and (II) are the same.

38. A molding obtained from the thermoplastic molding material according to claim 29.
